(19) United States
(12) Patent Application Publication
(10) Pub. No.: US 2004/0027749 A1
(43) Pub. Date: Feb. 12, 2004

(54) Detection of arcing in dc electrical systems

(76) Inventors: Joseph C. Zuercher, Brookfield, WI (US); Jerome K. Hastings, Sussex, WI (US); Engelbert Hetzmannseder, Milwaukee, WI (US); John B. Pardee, Franklin, WI (US); Charles J. Tennies, Waukesha, WI (US)

Correspondence Address: ECKERT SEAMANS CHERIN & MELLOTT, 600 GRANT STREET, 44TH FLOOR, PITTSBURGH, PA, 15219

(21) Appl. No.: 10/416,611

(22) PCT Filed: Nov. 9, 2001
(86) PCT No.: PCT/US01/46929

(51) Int. Cl. H02H 3/00

(52) U.S. Cl. 361/62

(57) ABSTRACT

Arcing faults in dc electric power systems are detected by apparatus which responds to a predetermined drop either in voltage across, or current drawn by, a dc load. The voltage and current drops can be measured values or scaled to the source voltage. In another arrangement, the load current is interrupted momentarily when a step decrease in current is detected. If the dc current does not return, within a predetermined margin, to the decreased value before interruption, arcing is indicated. In a third embodiment, drift of the load current following detection of a step decrease, either upward toward a short or downward toward an open circuit, is taken as an indication of arcing.

### BACKGROUND OF THE INVENTION

1. Field of the Invention

This invention relates to detection of and/or protection against arcing in dc electrical systems including parallel arcs and series arcs.

2. Background Information

It is common to provide overload, and sometimes overcurrent, protection in de electrical systems. Overload protection is typically provided by either a thermal element which emulates the heating of the distribution wiring and opens a contact when the bimetal reaches a certain temperature, or an electronic circuit which simulates the same thermal process. Overcurrent protection is typically provided by an instantaneous trip feature which opens the circuit breaker rapidly if the current exceeds a particular threshold, such as would be reached by a short circuit, and is implemented by a magnetic trip device or an electronic simulation. A fuse is a disposable thermal trip unit with no instantaneous capability.

In addition to overload and short circuit protection, there is developing interest in protection in dc electrical systems against arc faults. Arc faults involve a highly concentrated region of heat production, a type of “hot spot”, that can result in insulation breakdown, production of combustion products, and the ejection of hot metal particles. It can also result from broken conductors or poor connections.

Arc faults can be series or parallel. Examples of a series arc are a broken wire where the ends are close enough to cause arcing, or a poor electrical connection. Parallel arcs occur between conductors of different potential including a conductor and ground. Arc faults occur in series with the source and series arcs are further in series with the load. Arc faults have a relatively high impedance. Thus, a series arc results in a reduction in load current and is not detected by the normal overload and overcurrent protection of conventional protection devices. Even the parallel arc, which can draw current in excess of normal rated current in a circuit, produces currents which can be sporadic enough to yield RMS values less than that required to produce a thermal trip, or at least delay operation. Effects of the arc voltage and line impedance often prevent the parallel arc from reaching current levels sufficient to actuate the instantaneous trip function.

For many reasons, automotive circuits will be migrating to higher voltages such as 36 or 42 volts which are disproportionately more prone to damage from arcs than the present 14 volt circuits, due principally to the arc voltage being between 12 and 30 volts. Even 28 volt circuits, common in the aerospace industry, have been shown to provide an environment that supports sustained arcing. The single most aggravating factor beyond that found in residential power systems is vibration with significant humidity and dirt sometimes being aggravating factors. In addition, the telecommunications field uses 24 volt (and may migrate to 48 volt) dc systems which are susceptible to arcing. Arcs at these voltages cannot preexist, i.e., must be “drawn” by a contact being separated. If they are initially extinguished to an open circuit, they should not reoccur, in theory. But the presence of carbonization or the introduction of other contaminants dynamically, ionized gas (very short lived) and vibration, which can recontact the surfaces, can make multiple occurrences not uncommon. This is particularly true of a moving vehicle travelling through the elements.

### SUMMARY OF THE INVENTION

This invention is directed to apparatus for detecting and protecting against arc faults, both series and parallel, in dc circuits. It includes detection of decreases in the voltage across or current through the load detected by a local sensor and analyzed either locally or remotely. In the case of remote analysis, the sensor and control information can be transmitted by a carrier on the branch circuit or by a separate communication link such as a multiplexed system. It further includes switches which isolate the arc fault locally by disconnecting an affected load downstream of the arc or by turning off the entire branch upstream. One aspect of the invention includes the detection of the repetitive step changes produced by the arc. It also embraces monitoring the current which can follow the initial step changes in a dc arc fault to distinguish over other phenomenon, such as turning off of a load, by observing the drift of the arc current upward until the fault collapses to a short circuit, or the drift downward until the fault open circuits and the current drops to zero.

In accordance with another aspect of the invention, series arcs can be detected by momentarily turning off the current upon detection of a step drop in current. If when the current is turned back on the amplitude is about the same as when it was turned off, then some other phenomenon was the cause. If the current after turn on is not about what it was after the step decrease, whether significantly greater, or less, an arc fault which has collapsed to a short or one which has collapsed to an open circuit has occurred, respectively.

### BRIEF DESCRIPTION OF THE DRAWINGS

A full understanding of the invention can be gained from the following description of the preferred embodiments when read in conjunction with the accompanying drawings in which:

FIG. 1 is a current waveform diagram for series arcs in a dc electrical system.

FIG. 2 is a voltage waveform produced by a series arc in a dc electrical system.

FIG. 3 is a schematic circuit diagram illustrating a first embodiment of the invention implementing local series arc detection and load shedding.

FIG. 4 is a schematic circuit diagram of a second embodiment of the invention implementing local detection and local load shedding with communication of source voltage.

FIG. 5 is a schematic circuit diagram of a third embodiment of the invention implementing local sensing for an arc fault with central arc fault detection and response.

FIG. 6 is a schematic circuit diagram of another embodiment employing a multiplexed system for communicating between the load and a central location.

FIG. 7 is a schematic circuit diagram of an embodiment which disconnects the current momentarily to extinguish the arc and then checks the current level.

FIG. 8 is a schematic circuit diagram of another embodiment which detects series arcs and can distinguish between series arcs which collapse to a short circuit and those which collapse to an open circuit.

FIG. 9 is a current waveform diagram for a parallel arc in a dc electrical system.

FIG. 10 is a schematic circuit diagram of an embodiment of the invention similar to that illustrated in FIG. 3, but which responds to changes in de load current.

FIG. 11 is a schematic circuit diagram of an embodiment of the invention similar to that illustrated in FIG. 4, but which responds to changes in dc load current.

FIG. 12 is a schematic circuit diagram of an embodiment of the invention similar to that illustrated in FIG. 5, but which responds to changes in dc load current.

FIG. 13 is a schematic circuit diagram of an embodiment of the invention similar to that illustrated in FIG. 6, but which responds to changes in dc load current.

### DESCRIPTION OF THE PREFERRED EMBODIMENTS

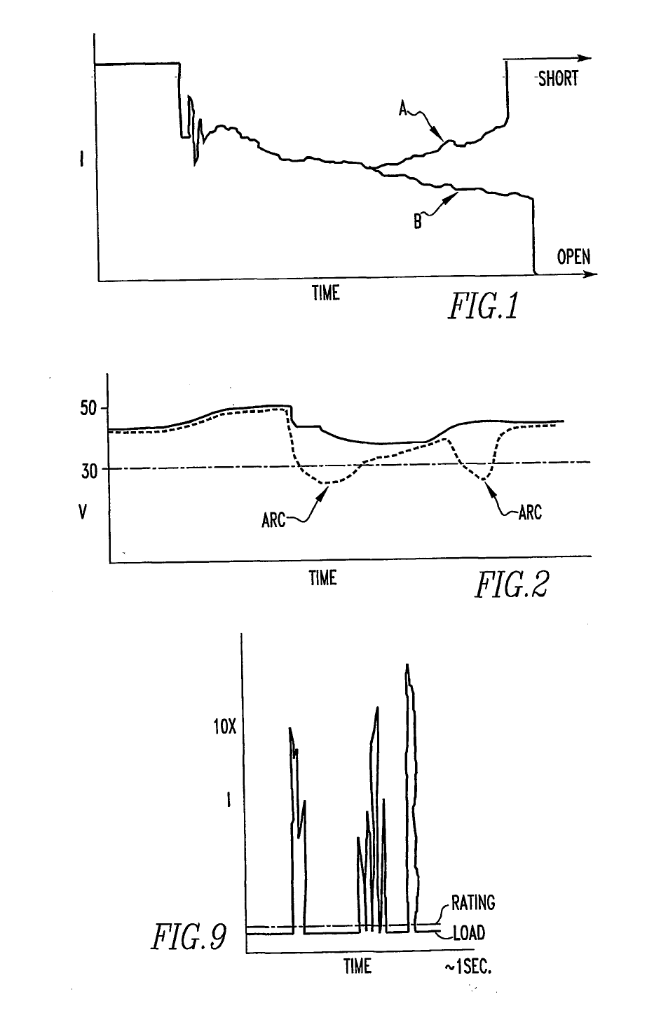

FIGS. 1 and 2 illustrate typical examples of current and voltage waveforms, respectively, produced in a dc electrical system by a series arc. As can be seen from FIG. 1, at initiation of the arc there are several step changes in current followed by a noisy sustained period. The arc then either collapses to a short, in which case the load current begins to drift upward and then jumps to its former value (trace A), until a second arc occurs, or the arc collapses to an open circuit in which case the current drifts downward and then falls to zero (trace B).

FIG. 2 illustrates that in a 42 volt dc system the source voltage shown in solid line and the voltage across the load shown in the dash line are both at 42 volts until an arc occurs. Voltage across the load then drops substantially as the arc introduces a substantial impedance in series with the load. We have found that a substantial reduction such as to less than about 75% of the normal system voltage is an indication of an are. Thus, in a 42 volt system, if the voltage across the load falls below about 30 volts, a series arc is indicated. Notice that the source voltage can also be pulled down by the fault but a difference of at least about 12 volts exists between the source voltage and the voltage across the load. As the arc is extinguished, both the source and load voltage can return to normal until another arc occurs. It is also possible that the load voltage drops to zero if the arc extinguishes to an open circuit. Due to the effects of vibration and/or carbon, a restrike is still possible.

It must be kept in mind that there are phenomena in the dc circuit which can produce waveforms which must be distinguished from arc faults. For instance, turning a load off and on can produce step changes.

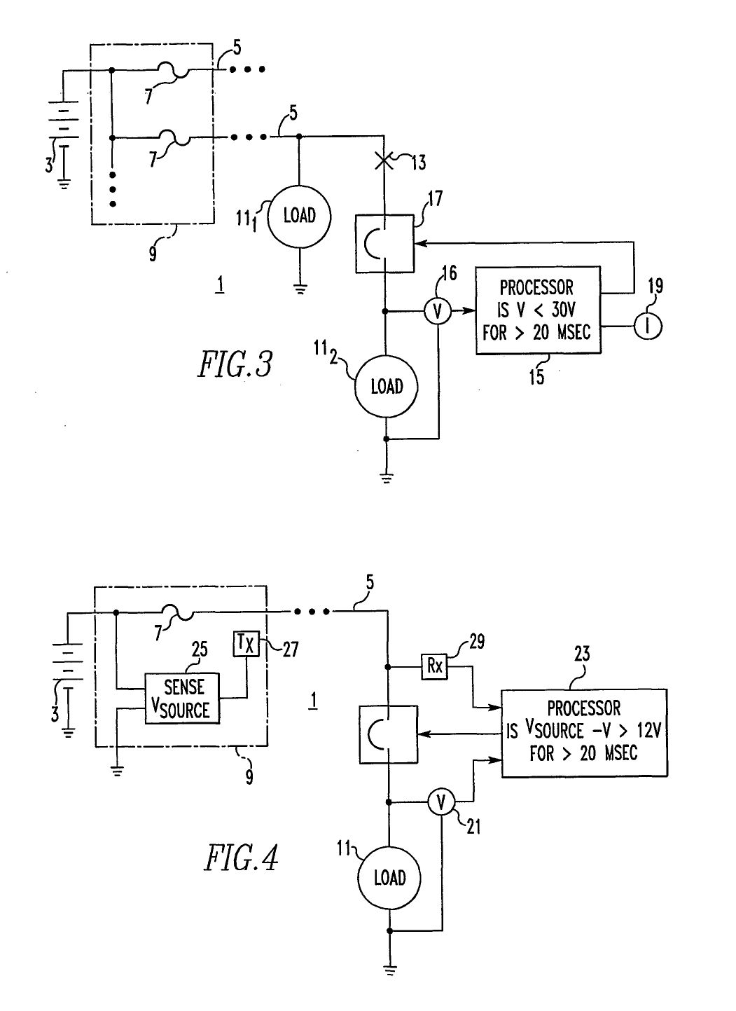

FIG. 3 illustrates schematically a dc electrical system 1 sourced by a battery 3 which can have, for example, a nominal voltage of 36 or 42 volts. The battery provides power to a number of branch circuits 5 each protected by a fuse 7 provided in a fuse or control box 9.

Each branch circuit 5 provides power to one or more loads 11₁, 11₂. A series arc 13 at the location shown will not appreciably affect the voltage across the load 11₁. However, as it is in series with the load 11₂ the voltage across this load will drop, as mentioned, about at least 25% or more initially. Thus, in accordance with this embodiment of the invention, a detector 15 monitors the voltage across the load 11₂ through voltage sensor 16, and if it falls below a threshold value for more than a predetermined time period for example, for a 42 volt system, below about 30 volts for more than at least about 10 msec and preferably more than about 20 msec, an arc fault is indicated. Detection of the arc can be used to open a local switch 17 in series with the arc. Alternatively, or in addition, an indicator 19, such as a light emitting diode (LED) can be actuated.

FIG. 4 illustrates another embodiment of the invention in which a sensor 21 provides the voltage across the load 11 to a local processor 23. This processor also receives a signal representing the source voltage from the power control module 9. A source voltage sensor 25 in the power control module generates a signal representing the source voltage which is provided to a transmitter 27 which modulates a carrier signal launched onto the branch circuit 5. The modulated carrier signal is picked up by receiver 29 which provides the source voltage indication to the processor 23. The processor 23 then subtracts the voltage across the load from the source voltage and if the difference exceeds a selected value for more than a predetermined time period, an arc is indicated and the local switch 17 is opened. For example, in a 42 volt dc system, if the difference is more than about 12 volts for more than 20 msec, a series arc is indicated.

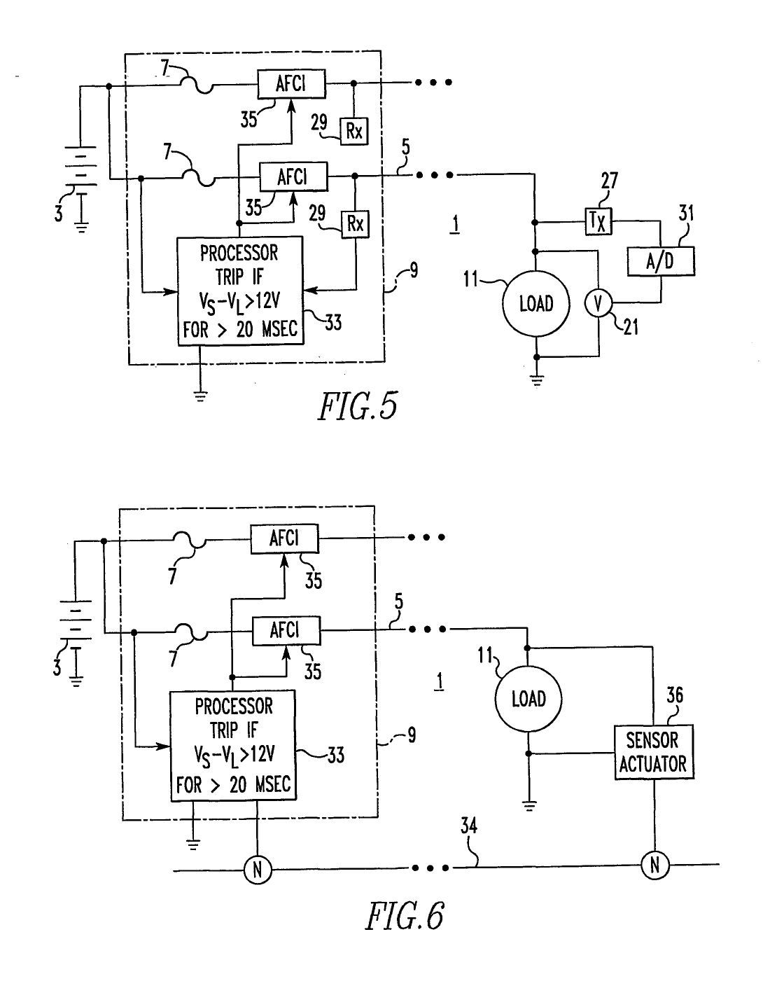

Turning to FIG. 5, the voltage across the load 11 is sensed locally, converted to a digital signal by the A/D converter 31 and used to modulate a carrier by the transmitter 27 for transmission over the branch circuit 5 to the power control module 9 where it is demodulated by a receiver 29 and provided to microprocessor 33. The microprocessor 33 checks for a series arc such as by determining whether the voltage across the load has dropped below the absolute threshold value or the locally measured value below the source voltage for the selected period of time, again, at least about 10 msec, but preferably about 20 msec. If an arc is detected, the microprocessor 33 can actuate a switch 35 in the power control module 9. This switch 35 can be, for instance, an arc fault current interrupter which also provides protection for parallel arcs. As the microprocessor 33 is in the power control module, it is in a position to provide arc fault protection for all of the branch circuits 5.

As an alternative to communication between the load and the power control module using a carrier signal on the branch circuit, in applications where a multiplexed system is available, the information from the power control module or from the load can be communicated in a packet on a communications bus 34, typically through a sensor/actuator chip 36 as shown in the embodiment of FIG. 6, other medium such as wireless communication could be used.

In each of the embodiments of FIGS. 3-6, series arcs could be detected by monitoring the current through the load rather than the voltage across the load. In that case, if the rated current through the load minus the sensed current divided by the rated current were less than a predetermined value such as for instance 0.7, a trip would be indicated. Again, the series arc places an impedance in series with the load which reduces the load current. If current is to be used, the rated current for each load must be known. And, for instance, if the load has multiple operating conditions, such as a number of speed settings, the rated current must be known for the operating condition.

In addition to using the drop in current or voltage produced by a series arc, other logic could be used in the embodiments of FIGS. 3-6. For instance, as both the current and downstream voltage waveforms of a series arc exhibit a series of step changes upon arc initiation, algorithms such as the time attenuated accumulation of such pulses as described in U.S. Pat. No. 5,691,869 could be employed. Furthermore, the logic of the arc fault detector described below in connection with parallel arcs in which the filtered load current in successive intervals is integrated and compared to detect randomness, could also be employed as the logic for these series arc detectors.

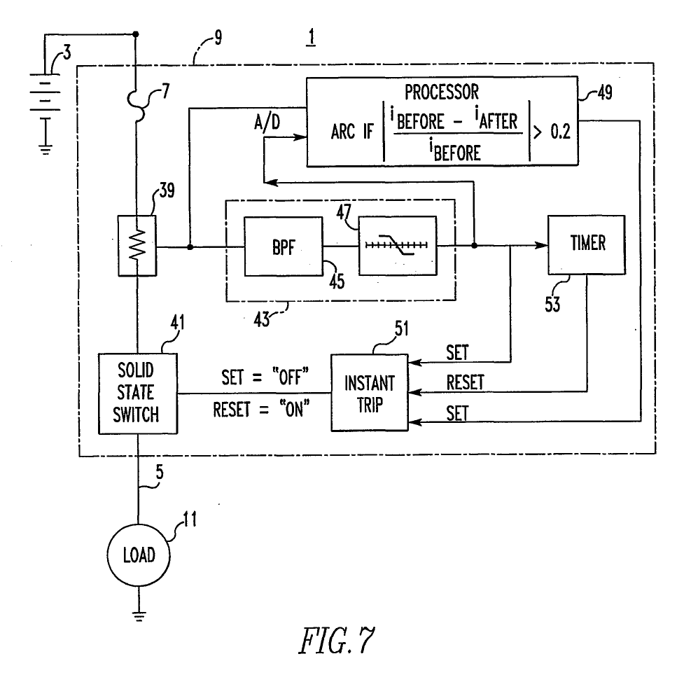

The embodiments of FIGS. 3-6 detect series arcs by monitoring the voltage across the load, and therefore, require sensors at each load. The embodiment shown in FIG. 7 detects series arcs by monitoring the current, and therefore, can be located remotely, and preferably in a central location such as the power control module 9. This embodiment monitors the branch current for step changes in current. As a step change in current could be due to the turning off or on of a load or a change in the operating condition of a load, this technique calls for turning off the current momentarily when a step change of a selected magnitude is detected. This interruption of the current will extinguish an arc. As will be recalled by reference by to FIG. 1, an arc can collapse to a short circuit or to an open circuit. Thus, if when the power is turned back on, the current goes to the value before the step decrease, or it goes to zero, the phenomenon was an arc. On the other hand, if the current returns to approximately the value that it was when the current was turned off, the change in current was not due to an arc, but rather to some other activity in the circuit such as the turning off of a load. The period of turn off should be long enough to extinguish an arc, but not long enough to cause serious interruption to the loads. An exemplary turn off time is about 5 msec to about 30 msec.

Turning to FIG. 7, the protection circuit 37, which is provided in the power control module 9, includes a current sensor 39 and a solid state switch 41 connected in the branch circuit 5. The sensed current signal is applied to an event detector 43 which includes a bandpass filter 45 which detects the step change, and a negative step threshold detector 47 which responds to a step drop in current greater than a selected value, such as for instance, about 25% to about 80%, typically about 50% in a 42V dc system. The occurrence of an event along with the sensed current is applied to a processor 49 which applies arc detection logic. Where the processor 49 is a digital processor, the sensed current is converted to a digital signal by an A/D converter provided with the processor. The occurrence of an event, that is a drop in load current of more than a selected value, sets an instantaneous trip logic 51 which turns off the solid state switch 41 to interrupt the current in the branch circuit 5. The event signal also starts a timer 53 which measures the preselected disconnect time, such as about 5 to about 30 msec and then resets the instantaneous trip logic 51 to turn the solid state switch back on. The arc detection logic subtracts the current before the disconnect, but after the initial step decrease, from the current after the reconnection and divides by the current before the disconnect. If the absolute value of the result is less than a predetermined value, such as about 0.2, then no arc has occurred. Otherwise, the processor 49 again sets the instantaneous trip logic 51 to turn off the solid state switch and protect the branch 5 from the detected series arc fault.

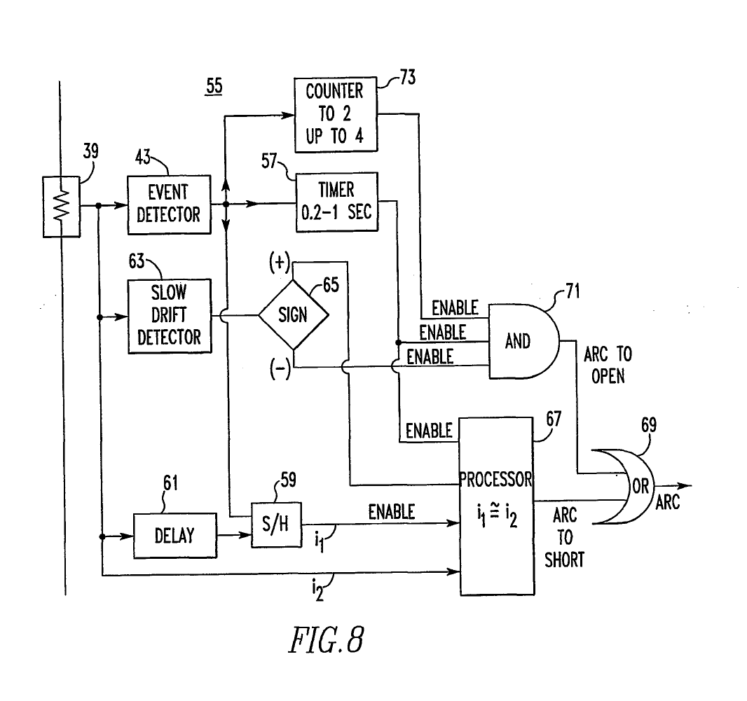

Another embodiment of the invention shown in FIG. 8 monitors the drift in current following the initial step changes in current produced by a series arc. Referring again to FIG. 1, it can be seen that the series arc current either drifts slowly higher and then collapses to a short so that the current returns to its initial value before the arc, or it slowly drifts downward and then collapses to an open circuit. Therefore, in this embodiment of the invention any slow drift in current following a step decrease is identified. If the slow drift is upward, the stored value of current before the step decrease is compared with the value of current after the period of drift, for example, about 0.1 to about 1 second. If these two current values are about equal, then there has been an arc which has shorted out. If the currents are not about equal, then there was no arc but a step change in current due to some other phenomenon. If the drift is negative following the step decrease, then the number of step decreases are counted and if a selected count of, such as for example, 2 to 4 is reached within a selected time interval, such as 0.1 to about 1 second, then there has been an arc which has collapsed to an open circuit.

Thus, as can be seen in FIG. 8, the current is sensed by the current sensor 39 and applied to an event detector 43. As in the embodiment of FIG. 7, this event detector 43 includes a bandpass filter and a negative threshold detector which detects step decreases in current of greater than a predetermined magnitude. Detection of the first step decrease in current starts a timer 57 and also enables a sample and hold circuit 59 which stores the value of the current before the step decrease which has been preserved by a delay circuit 61. A slow drift detector 63, which can be a low pass filter, also monitors the current. A sign detector 65 detects the polarity of the drift signal. If the polarity is positive, and the timer 57 is timed out, the stored initial current is compared with the existing current in processor 67. If these two currents are about equal, meaning that the arc has collapsed to a short, an arc to short signal is generated which is passed through an OR circuit 69. On the other hand, if the polarity of the slow drift signal as determined by the sign detector 65 is negative, an AND gate 71 is enabled. Meanwhile, a counter 73 counts the number of step decreases in current detected by the event detector 43 and if the count reaches a selected count within the interval set by the timer 57, the output of the AND gate 71 goes high to generate an arc signal at the output of the OR gate 69.

The above embodiments of the invention have addressed series arc faults in dc electrical systems. An example of a parallel arc in a dc electrical system is illustrated in FIG. 9. Such parallel arcs can be detected by utilizing the time attenuated accumulation of step changes in current produced by such an arc using the apparatus and techniques described in U.S. Pat. No. 5,691,869, which is hereby incorporated by reference. Such protection can be provided in the arc fault circuit interrupters 35 located in the power control module 9 such as shown in FIGS. 5 and 6. It should be understood that such parallel arc fault protection can be provided independent of or in conjunction with any of the techniques described herein for series arc fault detection.

Parallel arc faults in dc electrical systems can also be detected and responded to through use of the cyclic current integration comparison circuits and techniques described in U.S. Pat. No. 5,933,305. Arc faults are detected by bandpass filtering the current to generate a sensed current signal with a pulse each time an arc is struck. A resettable integrator integrates the sensed current repetitively over equal time intervals, such as each cycle of the ac current. The integrated value of the sensed current is compared with the value for the previous corresponding time interval stored in a sample and hold circuit, with the indications of interval to interval increases and decreases in the integrated sensed values for a selected number, such as 6, of the most recent time intervals stored in a shift register. For each time interval, a chaos detector counts the number of changes between increases and decreases for the selected number of most recent corresponding time intervals and accumulates a weighted sum of the counts which is time attenuated. When the sum reaches a predetermined amount, an output such as a trip signal for a circuit breaker is generated. When used to provide arc fault protection in an ac electrical system, the arc fault detector described in U.S. Pat. No. 5,933,305 uses time intervals which are multiples of the cycles of the fundamental frequency of the ac current, and are synchronized to the ac cycles by a zero crossing detector. As applied here to a dc electrical system, the zero crossing detector is not needed and the integration interval is selected as a multiple of cycles of the dominant frequency of the step changes in current produced by an arc, for example about 120-500 Hz. As mentioned above, this cyclic current integration comparison technique can also be used to detect series arcs as it is independent of the amplitude of the step changes in current produced by arcs and instead depends upon the randomness of the activity.

The cyclic current integration comparison technique can even be used in a dc electrical system having a PWM drive, such as a light dimmer. In such a case, the integration interval would be coordinated with the repetition rate of the PWM signal. Thus, the integration could be a multiple of the repetition rate and could even track a slowly changing repetition rate.

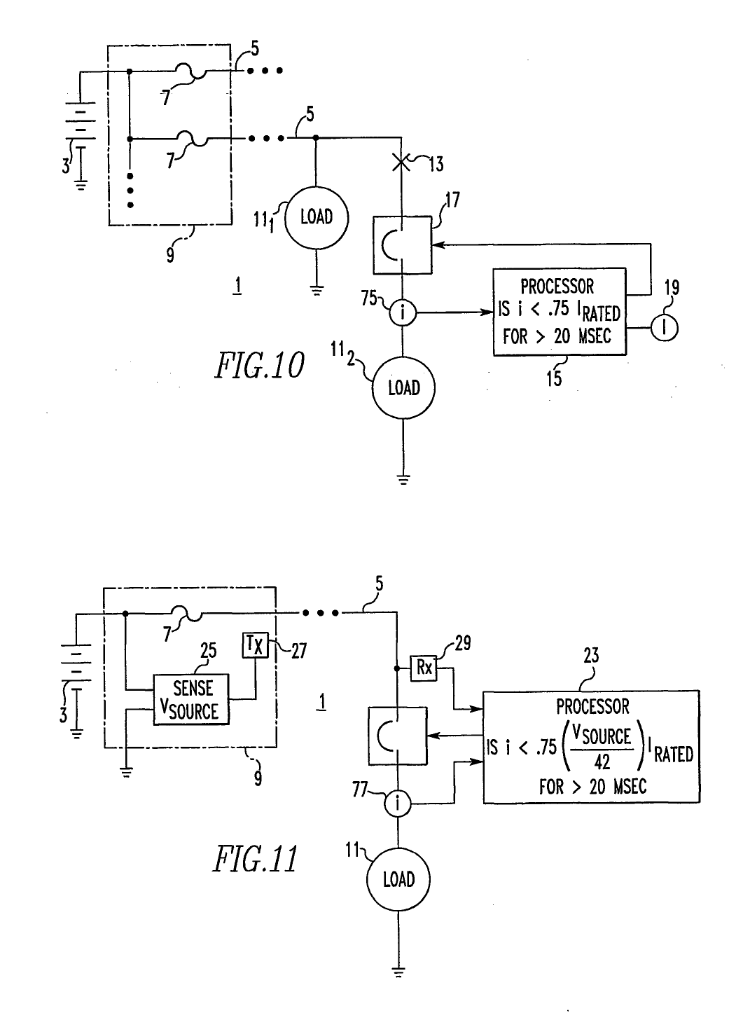

The invention also embraces the detection of a drop in dc current drawn by a dc load to indicate the presence of a dc arc. FIGS. 10-13 illustrate application of this technique of detecting a drop in dc current to the distribution systems illustrated in FIGS. 3-6 where a drop in load voltage was used to detect arcing. As can be seen in FIG. 10, a current sensor 75 senses current drawn by the load 11₂ and provides this measurement to the processor 15. Under normal conditions, the load 11₂ draws a rated current I_{rated}. A series arc 13 in the branch circuit 5 servicing the load 11₂ introduces a sizeable impedance in series with the load which is sharing the source voltage with the load and results in a reduction in the sensed current drawn by the load 11₂. If this sensed current drops at least 25% below the rated current, or in other words, the rated current drops to less than 0.75 of the rated current for a period of time, such as 10 msec., and preferably 20 msec., an arcing signal is generated which can be used to open the switch 17 to disconnect the load 11₂ from the dc source, and/or provide an indication of the arcing event, such as by lighting an LED 19.

In the dc distribution system 1 illustrated in FIG. 11, the processor 23 is provided not only with the current drawn by the load 11 as sensed by the current sensor 77, but also the source voltage V_{source} sensed by the voltage sensor 25 and transmitted over the branch line 5 by a transmitter 27 through modulation of a carrier signal. A receiver 29 demodulates the signal to extract the sensed dc source voltage for use by the processor 23. In order to accommodate for any variations in the dc source of voltage, the processor 23 generates an arcing signal if the current through the load 11 as sensed by the current sensor 77 is less than 0.75 of the rated current scaled to the dc source voltage, because if the source voltage drops, the current drawn by the load will drop by a proportional amount.

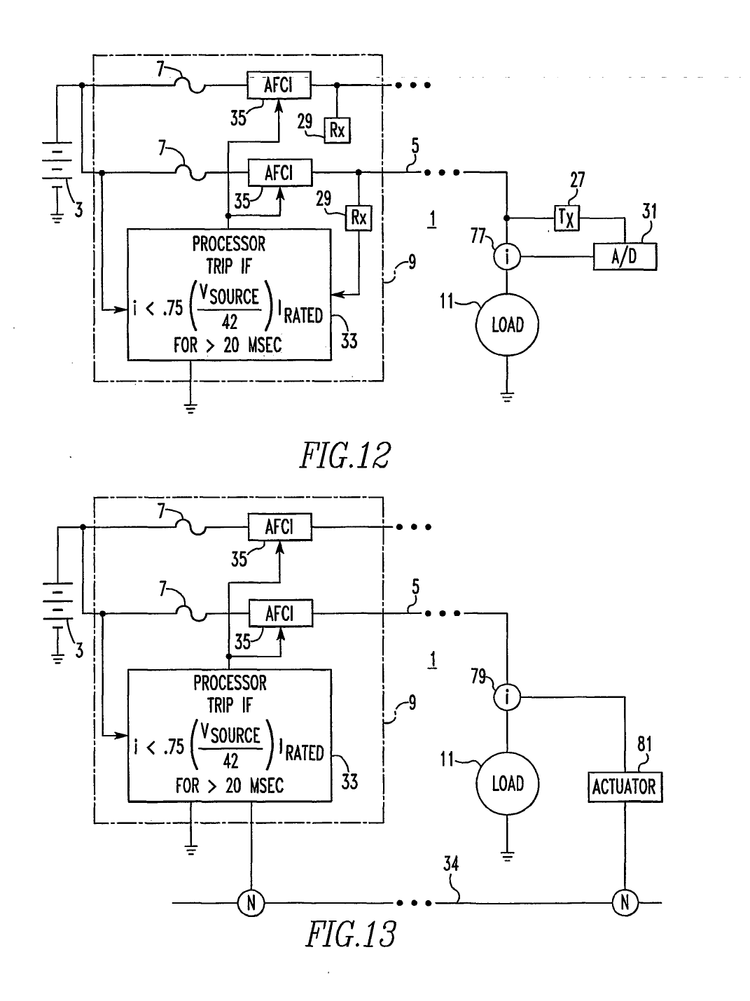

In FIG. 11, the processor 23 is located proximate the load 11. Hence, the sensed dc source voltage had to be transmitted to the processor 23. In the dc electrical system of FIG. 12, the processor 33 is located remotely from the load 11 and the current drawn by the load 11 and sensed by the current sensor 77 has to be transmitted to the remote processor 33. Thus, the sensed current is digitized in analog to digital converter 81 and then used by the transmitter 27 to modulate a carrier signal that is sent over the branch circuit 5 and demodulated by the receiver 29 to extract the current signal for processing by the processor 33. The processor 33, like the processor 23, generates an arcing signal if the sensed dc current falls at least to 0.75 times the rated current scaled to the dc source voltage for a period of time, such as at least 10 msec., but preferably 20 msec. The arrangement in FIG. 13 is similar to that in FIG. 12, except that the sensed current detected by the current sensor 79 is provided to the processor 33 over an external communication system such as a multiplex system where information is passed between the power control module 9 and the load 11 in packets over a communication bus 34, typically through an actuator chip 81.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. Apparatus providing protection against arcing in a distribution system providing dc power from a dc source to dc loads through branch circuits, said apparatus comprising:
voltage sensing means sensing dc voltage across at least one load;
processing means generating an arcing signal based upon sensed dc voltage across the at least one load; and
means responsive to the arcing signal.

2. The apparatus of claim 1, wherein the means responsive to the arcing signal comprises a switch disconnecting the at least one load from the dc power in response to the arcing signal.

3. The apparatus of claim 1, wherein the processing means comprises means generating an arcing signal when the sensed dc voltage across the at least one load drops by at least about 25% for a predetermined time interval.

4. The apparatus of claim 3, wherein the predetermined interval is about at least 10 msec.

5. The apparatus of claim 4, wherein the means responsive to the arcing signal comprises a switch disconnecting the at least one load from the dc power in response to the arcing signal.

6. The apparatus of claim 1, wherein the voltage sensing means further comprises means sensing the source voltage and the processing means comprises means generating an arcing signal when a difference between the source voltage and the sensed de voltage across the at least one load equals at least a predetermined value.

7. The apparatus of claim 6, wherein the predetermined value of the difference between the source voltage and the sensed dc voltage across the at least one load is at least about 12 volts.

8. The apparatus of claim 6, wherein the means sensing the source voltage is remote from the at least one load and wherein the processing means comprises a processor and means providing to the processor the source voltage and the sensed dc voltage across the at least one load.

9. The apparatus of claim 8, wherein the processor is located proximate the at least one load.

10. The apparatus of claim 9, wherein the means providing the source voltage to the processor comprises means transmitting the source voltage to the processor over the branch circuits.

11. The apparatus of claim 10, wherein the means transmitting the source voltage to the processor over the branch circuits comprises a transmitter modulating a carrier signal transmitted over the branch circuits by the source voltage.

12. The apparatus of claim 9, wherein the means providing the source voltage to the processor comprises a communication system separate from the branch circuits.

13. The apparatus of claim 8, wherein the processor is located proximate the means sensing the source voltage remote from the at least one load.

14. The apparatus of claim 13, wherein the means providing the sensed dc voltage across the at least one load to the processor comprises means transmitting the sensed dc voltage across the at least one load to the processor over the branch circuits.

15. The apparatus of claim 14, wherein the means transmitting the sensed de voltage across the at least one load to the processor comprises a transmitter modulating a carrier signal transmitted over the branch circuits by the sensed dc voltage across the at least one load.

16. The apparatus of claim 13, wherein the means providing the sensed dc voltage across the at least one load to the processor comprises a communication system separate from the branch circuits.

17. The apparatus of claim 13, wherein the means responsive to the arcing signal comprises a switch proximate the processor disconnecting the branch circuit providing dc power to the at least one load in response to the arcing signal.

18. Apparatus providing protection against arcing in a distribution system providing dc power from a dc source through a branch circuit to a dc load, said apparatus comprising:
current sensing means sensing current in the branch circuit;
a step detector responsive to a step decrease in current in the branch circuit sensed by the current sensing means;
disconnect means responsive to the step decrease in current detected by the step detector disconnecting the load from the dc source for a period of time and then reconnecting the load to the dc source; and
means generating an arcing signal when current sensed by the current sensing means after reconnection of the load to the dc source does not return within a selected margin of current sensed by the current sensing means at disconnection of the load from the dc source.

19. The apparatus of claim 18, wherein the disconnect means is further responsive to the arcing signal to maintain the load disconnected from the dc source in response to the arcing signal.

20. The apparatus of claim 18, wherein the means generating the arcing signal comprises a processor subtracting current sensed by the sensing means after reconnection of the load to the dc source from current sensed by the current sensing means at disconnection of the load from the dc source, dividing the absolute value of the difference by the current sensed by the current sensing means at disconnection and generating an arcing signal when the quotient is greater than a selected value.

21. The apparatus of claim 20, wherein the selected value is no more than about 0.2.

22. The apparatus of claim 18, wherein the step detector is responsive to a step decrease in current of at least about 25%.

23. The apparatus of claim 22, wherein the period of time during which the load is disconnected from the do source is about 5 to about 30 msec.

24. Apparatus providing protection against arcing in a dc distribution system providing dc power through a branch circuit to a dc load, said apparatus comprising:
a current sensor providing an indication of sensed current in the branch circuit;
a step detector detecting a predetermined step decrease in sensed current to a decreased value;
means detecting drift in the sensed current; and
means generating an arcing signal when the sensed current drifts from the decreased value.

25. The apparatus of claim 24, wherein the means generating an arcing signal generates the arcing signal when the sensed current at a predetermined time after the step decrease in current has drifted upward to about the value of the sensed current before the step decrease in sensed current.

26. The apparatus of claim 25, wherein the predetermined step decrease in current is about at least 25%.

27. The apparatus of claim 26, wherein the predetermined period of time is about 0.1 to about 1 sec.

28. The apparatus of claim 24, wherein the means generating the arcing signal further includes means responsive to a downward drift in sensed current following the step decrease in sensed current producing the arcing signal upon detection of a predetermined number of additional step decreases in current within a predetermined time period.

29. The apparatus of claim 28, wherein the predetermined count is about 2-4 counts.

30. The apparatus of claim 29, wherein the predetermined time period is about 0.1 to about 1 sec.

31. Apparatus providing protection against arcing in a distribution system providing dc power from a dc source to a load drawing a predetermined rated current from the dc source through a branch circuit, said apparatus comprising:
sensing means comprising current sensing means sensing dc current drawn by the load; and
processing means generating an arcing signal when the sensed dc current drawn by the load drops to at least a selected proportion of the predetermined rated current for a predetermined time interval.

32. The apparatus of claim 31 wherein the processing means generates an arcing signal when the sensed dc current drawn by the load drops at least to about 75% of the predetermined rated current.

33. The apparatus of claim 32 wherein the predetermined time interval is at least about 10 msec.

34. The apparatus of claim 33 wherein the means responsive to the arcing signal comprises a switch disconnecting the dc load from the dc power in response to the arcing signal.

35. The apparatus of claim 31 wherein the sensing means also includes source voltage sensing means sensing dc source voltage, and the processing means generates the arcing signal when the sensed dc current drops to a selected proportion of the rated current scaled to the dc source voltage.

36. The apparatus of claim 35 wherein the selected proportion of rated current is no more than 75% of the rated current.

37. The apparatus of claim 35 wherein the source voltage sensing means is remote from the de load and wherein the processing means comprises a processor and means providing to the processor the source voltage and the sensed dc current drawn by the load.

38. The apparatus of claim 37 wherein the processor is located proximate the de load.

39. The apparatus of claim 38 wherein the means providing the dc source voltage to the processor comprises means transmitting the dc source voltage to the processor over the branch circuit.

40. The apparatus of claim 38 wherein the means providing the dc source voltage to the processor comprises a communications system separate from the branch circuit.

41. The apparatus of claim 37 wherein the processor is located proximate the source voltage sensing means remote from the dc load.

42. The apparatus of claim 41 wherein the means providing the sensed dc current drawn by the dc load to the processor comprises means transmitting the sensed dc current drawn by the dc load to the processor over the branch circuit.

43. The apparatus of claim 39 wherein the means providing the sensed dc current drawn by the dc load to the processor comprises a communications system separate from the branch circuit.
